(19) United States
(12) Patent Application Publication
(10) Pub. No.: US 2025/0323592 A1
(43) Pub. Date: Oct. 16, 2025

(54) SYSTEM AND METHOD FOR CONTROLLING A MULTI-PHASE POWER INVERTER OF AN ELECTRIC MACHINE

(71) Applicant: GM GLOBAL TECHNOLOGY OPERATIONS LLC, Detroit, MI (US)

(72) Inventors: Michael Z. Pieszala, Panama City, FL (US); Benjamin S. Ngu, Royal Oak, MI (US); Khorshed Mohammed Alam, Canton, MI (US); Chandra S. Namuduri, Troy, MI (US); Muhammad Hussain Alvi, Troy, MI (US); Yilun Luo, Ann Arbor, MI (US)

(73) Assignee: GM GLOBAL TECHNOLOGY OPERATIONS LLC, Detroit, MI (US)

(21) Appl. No.: 18/634,538

(22) Filed: Apr. 12, 2024

(51) Int. Cl. H02P 27/08

(52) U.S. Cl. CPC H02P 27/08

(57) ABSTRACT

A multi-phase power inverter coupled to an electric machine includes a gate drive system including a gate controller operatively connected to gate drive circuits and hybrid switch power modules. The hybrid switch power modules are integrated into phase legs of the inverter that couple to the electric machine via AC power links. Each hybrid switch power module includes a first semiconductor switch connected in parallel with a second semiconductor switch, wherein the first semiconductor switch has performance characteristics that differ from the second semiconductor switch. The gate drive circuit includes a gate driver, a first variable resistance circuit, and a second variable resistance circuit. The gate controller is connected to the gate drive circuit via a plurality of links. The gate controller generates control signals that are communicated to the gate drive circuit to control the hybrid switch power module via the links.

### INTRODUCTION

The present disclosure relates to systems for controlling an electric machine. In one embodiment, this may include elements related to operating a multi-phase power inverter to provide electrical power to a traction motor of an electric vehicle.

In a power inversion process, pulse width modulation (PWM), pulse density modulation, delta-sigma modulation, pulse-frequency modulation, or other application-suitable binary (ON/OFF) switching control signals may be employed to facilitate transitions of switches between different states for purposes of powering an electric machine. The control signals, for example, may alternatingly control conducting states of the switches to convert direct current (DC) electrical power to alternating current (AC) electrical power to power the electric machine. Examples of switches used in higher power applications, such as those used for electrically powering a traction motor of an electric vehicle, may be voltage and/or current controlled devices that switch between ON and OFF states. Examples include wide bandgap (WBG), Gallium Nitride (GaN), Silicon Carbide (SiC), and other semiconductor switches, such as Metal Oxide Field Effect transistor (MOSFET) and Insulated Gate Bipolar Transistor (IGBT) semiconductor switches, which may be capable of supporting a wide variety of switching events. The rate, speed, timing, etc. of the switching events, or more specifically the transitioning of the switches between ON and OFF states (or opened and closed states), may be characterized as a slew rate. There may be benefits to having an ability to select and control the slew rate to minimize second order effects, such as overvoltage spikes, electromagnetic interference (EMI) bearing current, voltage overshoot, etc.

### SUMMARY

The concepts described herein provide a system, method, and apparatus for controlling semiconductor switches including hybrid switch power modules, such as may be employed in a multi-phase power inverter. The semiconductor switches may be arranged in parallel or series, wherein the semiconductor switches have different semiconductor technologies. The first and second semiconductor switches are controlled in a manner that coordinates or synchronizes current conductions during ON/OFF transients and OFF/ON transients by taking into account differences in gate voltages, thus providing overcurrent protection, overvoltage protection, and simplification of pulsewidth-modulation (PWM) control of semiconductor switches of hybrid switch power modules.

This system and method provide compensation for different operating characteristics of the different technologies employed in a hybrid switch power module, such as differences in switching delays or latencies of the individual switches employed therein, to ensure the switching of the first semiconductor switch and the switching of the second semiconductor switch are synchronized so that timing of current conduction therein is equivalent during ON/OFF transients and during OFF/ON transients.

This is achieved by using a gate driver with at least two sets of gate outputs for each of the types of semiconductor switches. The gate outputs for each of the switches are operated individually, or in parallel for a total of at least three different slew rate settings per semiconductor switch type.

An aspect of the disclosure may include a multi-phase power inverter coupled to an electric machine that includes a gate drive system including a gate controller operatively connected to a plurality of gate drive circuits and a plurality of hybrid switch power modules. The plurality of hybrid switch power modules are integrated into a plurality of phase legs of the multi-phase power inverter; the plurality of phase legs are arranged between a positive DC power rail and a negative DC power rail; and the plurality of phase legs are coupled to the electric machine via a plurality of AC power links. Each hybrid switch power module includes a first semiconductor switch connected in parallel with a second semiconductor switch between one of the positive power rail or the negative power rail and one of the plurality of AC power links of the respective phase leg of the multi-phase power inverter, the first semiconductor switch having a first set of performance characteristics and the second semiconductor switch having a second set of performance characteristics differing at least partially from the first set of performance characteristics. The gate drive circuit includes a gate driver, a first variable resistance circuit that connects to the first semiconductor switch, and a second variable resistance circuit that connects to the second semiconductor switch, the gate controller generates a plurality of control signals that are communicated to the gate drive circuit to control the hybrid switch power module, the gate controller is connected to the gate drive circuit via a plurality of links; and the gate controller communicates the plurality of control signals to the gate drive circuit via the plurality of links.

Another aspect of the disclosure may include the gate drive system having the plurality of control signals that include a first PWM control signal and a first slew rate signal, wherein the plurality of links includes a direct wired point-to-point link between the gate controller and the gate driver, and wherein the gate controller communicates the first PWM control signal to the gate driver via the direct wired point-to-point link to control the first semiconductor switch.

Another aspect of the disclosure may include the gate drive system having the plurality of links including a serial peripheral interface (SPI) link, or another communication protocol, wherein the gate controller communicates the first slew rate signal to the gate driver via the SPI link or other communication protocol to control the first semiconductor switch.

Another aspect of the disclosure may include the gate drive system having the plurality of links further including a plurality of point-to-point discrete links, wherein the first slew rate signal is arranged as a multi-bit discrete signal; and wherein the gate controller communicates the multi-bit discrete signal to the gate driver via the plurality of point-to-point links.

Another aspect of the disclosure may include the gate drive system having the plurality of links further including a point-to-point digital link; wherein the first slew rate signal is arranged as a multilevel digital signal; and wherein the gate controller communicates the multilevel digital signal to the gate driver via the point-to-point digital link.

Another aspect of the disclosure may include the gate drive system having a desaturation protection circuit that is connected to the hybrid switch power module, to protect the hybrid switch power module from a short-circuit fault.

Another aspect of the disclosure may include the gate drive system having a desaturation sensor arranged to monitor an electrical potential across the hybrid switch power module. The gate controller is arranged to generate first and second control signals, the first and second control signals being transferred to respective gates of the first and second semiconductor switches, and determine, via the desaturation sensor, the electrical potential across the hybrid switch power module in response to the first and second control signals.

Another aspect of the disclosure may include the gate drive system having the gate controller arranged to detect a fault in one of the first and second semiconductor switches based upon the electrical potential across the hybrid switch power module that was determined in response to the first and second control signals.

Another aspect of the disclosure may include the gate drive system having a desaturation sensor arranged to monitor an electrical potential across one of the first and second semiconductor switches of the hybrid switch power module; wherein the gate controller is arranged to generate first and second control signals, the first and second control signals being transferred to a gate of the one of the first and second semiconductor switches. The gate controller determines, via the desaturation sensor, the electrical potential across the one of the first and second semiconductor switches in response to the first and second control signals; and detects a fault in the one of the first and second semiconductor switches based upon the electrical potential.

The above summary is not intended to represent every possible embodiment or every aspect of the present disclosure. Rather, the foregoing summary is intended to illustrate some of the aspects and features disclosed herein. The above features and advantages, and other features and advantages of the present disclosure, will be readily apparent from the following detailed description of representative embodiments and modes for carrying out the present disclosure when taken in connection with the accompanying drawings and the claims.

### BRIEF DESCRIPTION OF THE DRAWINGS

One or more embodiments will now be described, by way of example, with reference to the accompanying drawings, in which:

FIGS. 1 and 2 schematically illustrate details related to an embodiment of an Electric Power System (EPS) for transferring electric power between a rechargeable electric energy storage system (RESS) and a multi-phase rotary electric motor/generator (electric machine), in accordance with the disclosure.

FIG. 3 illustrates a flowchart of a method for variable slew rate powering of an electric machine in accordance with one aspect of the present disclosure.

FIG. 4 illustrates a slew rate graph in accordance with one aspect of the present disclosure.

FIGS. 5, 6 and 7 schematically illustrate partial schematic views of embodiments of an EPS including a gate drive system, a portion of a power inverter module including a gate drive circuit, and a hybrid switch power module, in accordance with the disclosure.

FIGS. 8-1 and 8-2 schematically illustrate partial cutaway plan views of an integrated circuit that includes elements of a pair of hybrid switch power modules 75, in accordance with the disclosure.

FIG. 9 schematically illustrates elements of an embodiment of a fault monitoring and detection arrangement that may be employed on an embodiment of a gate drive system for an EPS, in accordance with the disclosure.

FIG. 10 schematically illustrates elements of another embodiment of a fault monitoring and detection arrangement that may be employed on an embodiment of a gate drive system for an EPS, in accordance with the disclosure.

The appended drawings are in simplified form and are not to precise scale, and may present a somewhat simplified representation of various features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure.

For purposes of convenience and clarity, directional terms such as top, bottom, left, right, up, over, above, below, beneath, rear, and front, may be used with respect to the drawings. These and similar directional terms are not to be construed to limit the scope of the disclosure. Furthermore, the disclosure, as illustrated and described herein, may be practiced in the absence of an element that is not specifically disclosed herein.

The use of ordinals such as first, second and third does not necessarily imply a ranked sense of order, but may distinguish between multiple instances of an act or structure.

The following detailed description is merely illustrative in nature and is not intended to limit the application and uses. Furthermore, there is no intention to be bound by an expressed or implied theory presented herein. Throughout the drawings, corresponding reference numerals indicate like or corresponding elements and features.

Detailed embodiments of the present disclosure may be disclosed herein; however, it may be understood that the disclosed embodiments may be merely illustrative of the disclosure that may be embodied in various and alternative forms. The figures may not be necessarily to scale; some features may be exaggerated or minimized to show details of particular components. Therefore, specific structural and functional details disclosed herein may need not to be interpreted as limiting, but merely as a representative basis for teaching one skilled in the art to variously employ the present disclosure.

The present disclosure is susceptible of being embodied in various forms. Representative examples of the disclosure are shown in the drawings and described herein in detail as non-limiting examples thereof. To that end, elements and limitations described herein, but not explicitly set forth in the claims, are not to be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including,” “containing,” “comprising,” “having,” and the like shall mean “including without limitation.” Moreover, words of approximation such as “about,” “almost,” “substantially,” “generally,” “approximately,” etc., may be used herein in the sense of “at, near, or nearly at,” or “within 0-5% of,” or “within acceptable manufacturing tolerances,” or logical combinations thereof.

As used herein, the term “system” refers to mechanical and electrical hardware, software, firmware, electronic control componentry, processing logic, and/or processor device, individually or in combination, including without limitation: application specific integrated circuit (ASIC), an electronic circuit, a processor (shared, dedicated, or group) that executes one or more software or firmware programs, memory device(s) that electrically store software or firmware instructions, a combinatorial logic circuit, and/or other components that provide the described functionality.

As employed herein, terms such as “vertical”, “horizontal”, “left”, “right”, “upper”, “lower”, “top”, “bottom” and similar expressions are non-limiting terms that merely describe the various elements as illustrated in the Figures, and are not intended to limit the scope of the disclosure.

As used herein, the term “electric machine” refers to a rotary electric motor/generator device including a rotor and a stator that is capable of converting electric power to mechanical power and/or converting mechanical power to electric power by electromagnetic effort.

The term “controller” and related terms such as microcontroller, control, control unit, processor, etc. refer to one or various combinations of Application Specific Integrated Circuit(s) (ASIC), Field-Programmable Gate Array(s) (FPGA), electronic circuit(s), central processing unit(s), e.g., microprocessor(s) and associated non-transitory memory component(s) in the form of memory and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning, buffer circuitry and other components, which can be accessed by and executed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms, and similar terms mean controller-executable instruction sets including calibrations and look-up tables. Each controller executes control routine(s) to provide desired functions. Routines may be executed at regular intervals, for example every 100 microseconds during ongoing operation. Alternatively, routines may be executed in response to occurrence of a triggering event. Communication between controllers, actuators and/or sensors may be accomplished using a direct wired point-to-point link, a networked communication bus link, a wireless link, or another communication link. Communication includes exchanging data signals, including, for example: electrical signals via a conductive medium; electromagnetic signals via air; optical signals via optical waveguides; etc. The data signals may include discrete, analog and/or digitized analog signals representing inputs from sensors, actuator commands, and communication between controllers.

The term “signal” refers to a physically discernible indicator that conveys information, and may be a suitable waveform (e.g., electrical, optical, magnetic, mechanical, or electromagnetic), such as DC, AC, sinusoidal-wave, triangular-wave, square-wave, vibration, and the like, that is capable of traveling through a medium.

The terms “calibration”, “calibrated”, and related terms refer to a result or a process that correlates a desired parameter and one or multiple perceived or observed parameters for a device or a system. A calibration as described herein may be reduced to a storable parametric table, a plurality of executable equations or another suitable form that may be employed as part of a measurement or control routine.

A parameter is defined as a measurable quantity that represents a physical property of a device or other element that is discernible using one or more sensors and/or a physical model. A parameter can have a discrete value, e.g., either “1” or “0”, or can be infinitely variable in value.

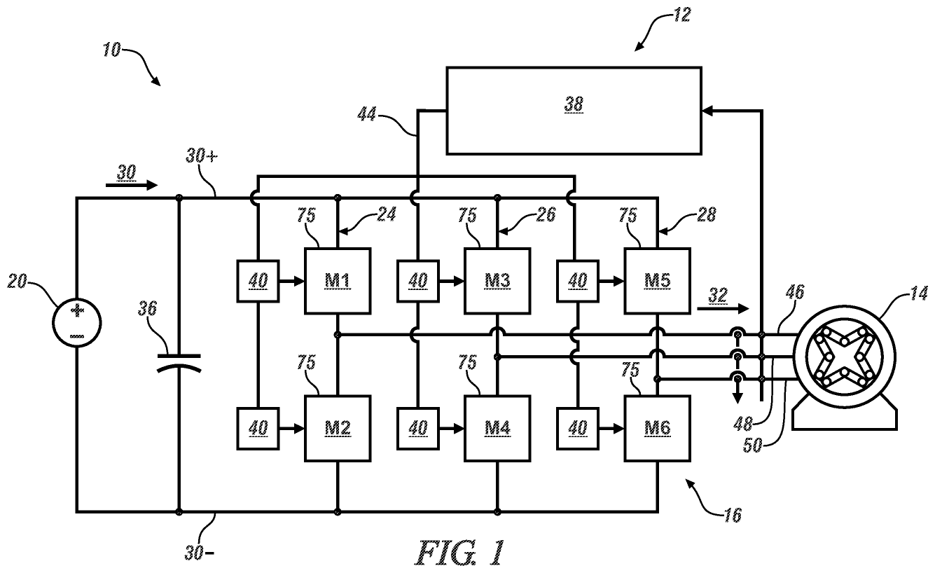

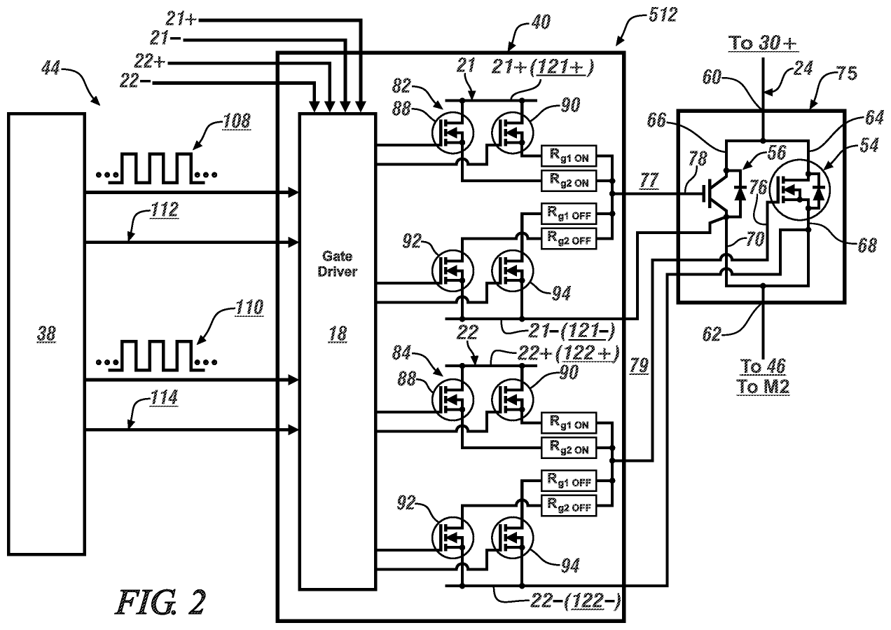

Referring to the drawings, wherein like reference numbers refer to the same or like components in the several Figures, FIGS. 1 and 2 schematically illustrate details related to an embodiment of an Electric Power System (EPS) 10 that includes a rechargeable electric energy storage system (RESS) 20, a gate drive system 12, a multi-phase power inverter (PIM) 16, and a multi-phase rotary electric motor/generator (electric machine) 14. The EPS 10 is capable of converting DC electric power to AC electric power to generate torque via the electric machine 14, and is capable of regeneratively reacting torque input from the electric machine 14 to generate DC electric power that is storable on the RESS 20. In one embodiment, the EPS 10 is an electrified vehicle system.

The RESS 20 connects to the PIM 16 via a high-voltage power bus 30 that includes a positive high-voltage (HV) DC power rail (HV+) 30+ and a negative high-voltage (HV) DC power rail (HV−) 30−.

The PIM 16 is a multi-phase power inverter, which may include, by way of non-limiting examples, a two-phase inverter, a three-phase inverter, a four-phase inverter, etc. As shown and described herein, the PIM 16 is a three-phase power inverter. The PIM 16 includes a plurality of phase legs that have a plurality of hybrid switch power modules 75, indicated as M1, M2, M3, M4, M5 and M6. The PIM 16 is arranged with a first phase leg 24, a second phase leg 26, and a third phase leg 28. The first phase leg 24 is composed of a pair of the hybrid switch power modules M1, M2 that are arranged in series between HV+30+ and HV−30−, and are connected at a first node that connects via a first AC power link 46 to a first phase of the electric machine 14. The second phase leg 26 is composed of hybrid switch power modules M3, M4 that are arranged in series between HV+30+ and HV−30−, and are connected at a second node that connects via a second AC power link 48 to a second phase of the electric machine 14. The third phase leg 28 is composed of hybrid switch power modules M5, M6 that are arranged in series between HV+30+ and HV−30−, and are connected at a third node that connects via a third AC power link 50 to a third phase of the electric machine 14.

The EPS 10 includes the gate drive system 12 for controlling operation of the PIM 16, and thus controlling operation of the electric machine 14. When an embodiment of the EPS 10 is deployed as an electrified vehicle system, it may be deployed to provide mechanical, tractive torque that is useable to propel the vehicle or otherwise perform work on-vehicle.

The gate drive system 12 includes a gate controller 38, and a plurality of gate drive circuits 40, wherein the gate drive circuits 40 are arranged to individually control the plurality of hybrid switch power modules 75 between opened and closed states to facilitate converting a direct current (DC) output 30 of the RESS 20 to a plurality of alternating current (AC) inputs that are transferred to the electric machine 14 via the first, second, and third AC power links 46, 48, 50, respectively.

The gate controller 38 generates a plurality of control signals 44 to individually control the plurality of gate drive circuits 40, and thus individually control activation and deactivation of the plurality of hybrid switch power modules 75 in response to a request for output torque from the electric machine 14. Additional details related to the gate controller 38, the plurality of gate drive circuits 40, and the control signals associated therewith, e.g., pulsewidth modulated (PWM) control signals and slew rate control signals, are described with reference to FIG. 2, et seq.

Referring again to FIG. 1, the RESS 20 may be a battery or other energy storage device capable of supplying electrical power to and receiving electrical power from the electric machine 14 via the PIM 16. A DC link capacitor 36 may be included to smooth, filter, and otherwise process the DC output 30 for use with the PIM 16. The gate controller 38 of the gate drive system 12 may individually and specifically control the plurality of gate drive circuits 40 to control a rate, speed, timing, etc. of switching events for the hybrid switch power modules 75, including those used to control transitioning of the hybrid switch power modules 75 between ON and OFF or opened and closed states. The transitioning of the hybrid switch power modules 75 between states may be performed according to corresponding plurality of control signals 44 provided from the gate controller 38. The gate controller 38 may be configured for individually providing the plurality of control signals 44 to each of the gate drive circuits 40. The gate controller 38 may include a non-transitory computer-readable storage medium having a plurality of non-transitory instructions stored thereon, which when executed with an associated one or more processors, may be operable in accordance with the present disclosure to facilitate generating the plurality of control signals 44 in a manner that provides a desirable slew rate while also managing the AC input 32 as needed for proper powering of the electric machine 14. The gate controller 38 may be used in this manner to facilitate switching events for the hybrid switch power modules 75 whereby the DC output 30 may be converted to the AC input 32. The AC input 32 may be generated in the illustrated manner to provide a polyphase output having a plurality of AC power links 46, 48, 50 that couple to the electric machine 14, which are shown for non-limiting purposes to correspond with a three-phase implementation where a three-phase AC input 32 is provided to an AC bus or windings of the electric machine 14, such as via a corresponding input terminal for the associated AC input 32.

FIG. 2 illustrates a partial schematic view of an embodiment of the gate drive system 12 and PIM 16 of the EPS 10, including one of the gate drive circuits 40 and a first of the first hybrid switch power modules M1 75. The circuit topology and configuration are representative of how each of the plurality of gate drive circuits 40 may be arranged and controlled to interact with each of the other hybrid switch power modules 75, i.e., hybrid switch power modules M2, . . . . M6. The gate drive system 12 includes gate controller 38, gate drive circuit 40, and hybrid switch power module 75, which connects between one of the positive power rail 30+ (as illustrated) or the negative power rail 30−, and to one of the AC power links 46, 48, 50 of the electric machine 14, as shown with reference to FIG. 1.

Referring again to FIG. 2, the gate controller 38 generates the plurality of control signals 44 that are communicated to the plurality of gate drive circuits 40 to individually control activation and deactivation of the plurality of hybrid switch power modules 75 in response to a request for output torque from the electric machine 14. The plurality of control signals 44 may be communicated to the plurality of gate drive circuits 40 via one or more of direct wired point-to-point links including direct wired point-to-point discrete links, direct wired point-to-point digital links, etc., or serial peripheral interface (SPI) links, universal asynchronous receiver-transmitter (UART) devices, wireless links, etc. The plurality of control signals 44 provided to each of the plurality of gate drive circuits 40 include a first PWM control signal 108 and a first slew rate signal 112 for controlling the first semiconductor switch 56 between ON and OFF states, and a second PWM control signal 110 and a second slew rate signal 114 for controlling the second semiconductor switch 54 between ON and OFF states.

Each of the gate drive circuits 40 includes a gate driver 18 that connects to and controls first and second variable resistance circuits 82, 84, respectively, to control the respective hybrid switch power module 75.

Each of the hybrid switch power modules 75 includes two or more semiconductor switches 56, 54, wherein the switches 56, 54 have differing performance characteristics. The illustrated example includes the hybrid switch power module 75 having a first semiconductor switch (Q1) 56 connected in parallel with a second semiconductor switch (Q2) 54. It is appreciated that there may be three or more semiconductor switches connected in parallel within the scope of the disclosure. The first and second semiconductor switches 56, 54 are shown to be connected in parallel for illustrative purposes as the present disclosure fully contemplates the switches 56, 54 being connected in series and/or additional switches being employed, with the additional switches being connected in series and/or in parallel with each other. The first and second semiconductor switches 56, 54 may be of a different technology such that the first semiconductor switches 56 may have a first set of performance characteristics and the second semiconductor switches 54 may have a second set of performance characteristics differing at least in part from the first set of performance characteristics. One aspect of the present disclosure contemplates varying slew rates of the semiconductor switches 56, 54 to optimize the DC-to-AC conversion, optionally by leveraging use of the differing performance characteristics of the semiconductor switches 56, 54 according to those most suitable for the present operating conditions of the electric machine.

In one operating state, the first and second semiconductor switches 56, 54 are activated substantially simultaneously in accordance with the concepts described herein. In one operating state, one of the first and second semiconductor switches 56, 54 is activated, e.g., is pulsewidth-modulation controlled, and the other of the first and second semiconductor switches 56, 54 is deactivated, i.e., is controlled to an OFF state.

The first and second semiconductor switches 56, 54 may be composed of various semiconductors or other types of switches 56, 54 having differing technologies. This may include but not be limited to the first semiconductor switches 56 being Metal-Oxide-Semiconductor Field-Effect Transistors (MOSFETs) or Silicon Carbide (SIC) MOSFETs, the second semiconductor switches 54 being Insulated Gate Bipolar Transistors (IGBTs) or Si IGBTs, and/or according to other differences, e.g., the first semiconductor switches 56 may be silicon type devices, and the second semiconductor switches 54 may be wide bandgap (WBG) type devices, wherein the WBG devices may be the same device in one embodiment, or may be different technologies in one embodiment. In this configuration, the first set of performance characteristics may correspond with a first switching speed rating, a first voltage rating, a first current rating, and/or a first efficiency rating, and the second set of performance characteristics may correspond with a second switching speed rating, a second voltage rating, a second current rating, and/or a second efficiency rating. The first switching speed rating may be faster than the second switching speed rating, the first voltage rating may be less than the second voltage rating, the first current rating may be less than the second current rating, and/or the first efficiency rating may be greater than the second efficiency rating. The gate controller 38 may utilize these performance differences to control transitioning of the first and second semiconductor switches 56, 54 between ON and OFF states according to variable slew rates.

The hybrid switch power modules 75 may be individually fabricated as discrete or separate integrated circuits (IC), which may be packaged in a corresponding housing. The hybrid switch power modules 75 may each employ separate ICs for the first and second semiconductor switches 56, 54 and/or additional switches included thereon. The hybrid switch power modules 75 may include pins, traces, or other physical constructs to facilitate the electrical interconnections contemplated herein. While other arrangements are contemplated, the hybrid switch power modules 75 are shown to include an input 60 and an output 62 to the associated phase leg 24, a drain 64 of the first semiconductor switch 56 connected to a collector 66 of the second semiconductor switch 54, a source 68 of the first semiconductor switch 56 connected to an emitter 70 of the second semiconductor switch 54, and a plurality of interfaces operable with the gate drive circuits 40 to facilitate biasing a gate 78 of the first semiconductor switch 56 and biasing a second gate 76 of the second semiconductor switch 54.

Each gate drive circuit 40 includes first and second variable resistance circuits 82, 84, respectively, for controlling a respective hybrid switch power module 75. The variable resistance circuits 82, 84 may each include a plurality of buffer switches 88, 90, 92, 94 and a plurality of resistors including two ON resistors R_{Gg1_ON}, R_{g2_ON} and two OFF resistors R_{g1_OFF}, R_{g2_OFF}. The buffer switches 88, 90, 92, 94 may be operable between ON and OFF states to respectively connect and disconnect an associated one or more of the resistors to first and second low-voltage DC power buses 21, 22, respectively. The illustrated configuration includes each of the first and second variable resistance circuits 82, 84 including two ON buffer switches 88, 90 and two OFF buffer switches 92, 94, respectively, for connecting and disconnecting two ON resistors R_{G1_ON}, R_{G2_ON} and two OFF resistors R_{G1_OFF}, R_{G2_OFF} to the positive and/or negative power rails 21+, 21−, 22+, 22− and first and second gates 78, 76, respectively, of the corresponding first and second semiconductor switches 56, 54. The aforementioned elements of first variable resistance circuit 82 are powered via the first low voltage DC power bus 21 including a positive rail 21+ and a negative rail 21−, and the aforementioned elements of the second variable resistance circuit 84 are powered via second low voltage DC power bus 22 including a positive rail 22+ and a negative rail 22−. The gate driver 18 controls positive and negative DC voltage levels 121+, 121−, respectively, of the positive rail 21+ and negative rail 21−, respectively, of the first low voltage DC power bus 21, and controls positive and negative DC voltage levels 122+, 122−, respectively, of the positive rail 22+ and negative rail 22−, respectively, of the second low voltage DC power bus 22.

In one embodiment, the positive DC voltage level of the positive rail 21+ of the first low voltage DC power bus 21 differs from the positive DC voltage level of the positive rail 22+ of the second low voltage DC power bus 22.

In one embodiment, the positive DC voltage level of the positive rail 21+ of the first low voltage DC power bus 21 is the same as the positive DC voltage level of the positive rail 22+ of the second low voltage DC power bus 22.

In one embodiment, the negative DC voltage level of the negative rail 21− of the first low voltage DC power bus 21 differs from the negative DC voltage level of the negative rail 22− of the second low voltage DC power bus 22.

In one embodiment, the negative DC voltage level of the negative rail 21− of the first low voltage DC power bus 21 is the same as the negative DC voltage level of the negative rail 22− of the second low voltage DC power bus 22.

The gate controller 38 may be configured to generate the plurality of control signals 44 to provide each gate drive circuit 40 with corresponding first and second PWM control signals 108, 110 for respectively controlling the first and second semiconductor switches 56, 54 between ON and OFF states, i.e., PWM control, and first and second slew rate signals 112, 114 for respectively controlling first and second slew rates of the first and second semiconductor switches 56, 54. Specifically, and in one embodiment, the first variable resistance circuit 82 generates a first gate voltage 77 that is input to first gate 78 for controlling the first semiconductor switch 56 based upon the first PWM control signal 108 and the first slew rate signal 112, and the second variable resistance circuit 84 generates a second gate voltage 79 that is input to second gate 76 for controlling the second semiconductor switch 54 based upon the second PWM control signal 110 and the second slew rate signal 114.

As described herein, the control of one of, some of, or all of the first and second PWM control signals 108, 110 and the first and second slew rate signals 112, 114 is to synchronize the first switching transient in the first of the first and second semiconductor switches 56, 54 with the second switching transient in the second of the first and second semiconductor switches 56, 54 of the hybrid switch power module 75. In doing so, neither of the first and second semiconductor switches 56, 54 of the hybrid switch power module 75 is subjected to an increased or excessive current load during the ON/OFF transients and during the ON/OFF transients. Stated another way, the control of one of, some of, or all of the first and second PWM control signals 108, 110 and the first and second slew rate signals 112, 114 is to balance a first current load across the first semiconductor switch with a second current load across the second semiconductor switch during an activation-to-deactivation (ON/OFF) transient and during a deactivation-to-activation (OFF/ON) transient in each of the hybrid switch power module 75.

The gate drive circuit 40 includes the gate driver 18, which is operable for processing the first and second PWM control signals 108,110 and the first and second slew rate signals 112, 114 to implement the desired control via the variable resistance circuits 82, 84. The gate driver 18 may process the first and second slew rate signals 112, 114 to determine the desired combinations of the ON and OFF resistors and process the control signals 108, 110 to determine desired timing of the buffer switches 88, 90, 92, 94 between ON and OFF states. While the present disclosure fully contemplates additional ON and OFF resistors and/or ON and OFF buffer switches 88, 90, 92, 94 being employed to facilitate additional resistor combinations, the illustrated configuration provides three different resistance combinations for each of the ON and OFF resistors, i.e., ON resistors R_{g1_ON}, R_{g2_ON} and OFF resistors R_{g1_OFF}, R_{g2_OFF}. A duty cycle of the control signals 108, 110, which are shown to be pulse width modulated (PWM) signals. The PWM signal includes a frequency component and a duty cycle component, wherein the duty cycle component may be varied to finely adjust the gate voltage and/or current at precise levels depending on the desired slew rate, e.g., to facilitate adjusting the slew rate in real-time according to desired operation of the electric machine 14. While not shown in individual detail, a plurality of sensors or other features may be employed to facilitate measuring or otherwise determining a DC voltage of the RESS 20, a temperature of the DC link capacitor 36, a current of one or more of the AC inputs 32, and a junction temperature, a maximum discharge time, a drain-source voltage (Vds), a voltage threshold (Vth) of the hybrid switch power modules, i.e., hybrid switch power modules M1, M2, . . . . M6.

The gate controller 38 may process the sensor measurements, metrics, etc. to determine a desired slew rate for each of the hybrid switch power modules 75, which may include selecting the plurality of control signals 44 to optimize transitions between the opened and closed states as a function of operating conditions of the electric machine 14 and the first and second sets of performance characteristics.

The gate controller 38 may employ temperature (simulated, calculated, or measured) as an operating parameter for each semiconductor switch technology. By way of a non-limiting example, the semiconductor switches 56, 54 may have different performance characteristics, which may be employed as inputs that allow for temperature warning, shutdown limits, or protection for slew rate usages. The gate controller 38 may include a slew rate selection process based on individual or combinations of operating conditions such as, but not limited to: inverter terminal voltage, RESS open circuit voltage, RESS terminal, semiconductor switch temperature (measured or estimated), inverter output current, motor torque, motor speed, PWM frequency, PWM modulation type, dV/dt of dI/dt of the semiconductor switches, threshold voltage of the semiconductor switches, and/or voltage at the semiconductor switches 56, 54. Slew rate may be controlled by both the present/future operating conditions of the electric machine 14, and/or the present or future operating conditions of the electric propulsion system and/or other systems cooperating with the electric machine 14, e.g., the inverter may be controlled to set the torque and speed of the electric machine 14. The gate controller 38 may use one set of resistances for increasing efficiency in Enhanced Current Output Performance (ECOP) regions, use another set of resistances for peak current, and use the last set of resistances to increase losses in the PIM 16 for use of the hybrid switches 56, 54 individually or in parallel. This may be used to optimize losses in different operation areas by using specific semiconductor switches and slew rates in specific regions. Furthermore, optimization can be done based on using a combination of different semiconductor switches having different slew rates. The gate controller 38 may use the variable slew rates to decrease losses, increase peak performance, and decrease chip/die temperatures during operation of the power electronic system for parallel or individual semiconductor switch operation and/or to protect the semiconductor switches 56, 54 from overvoltage.

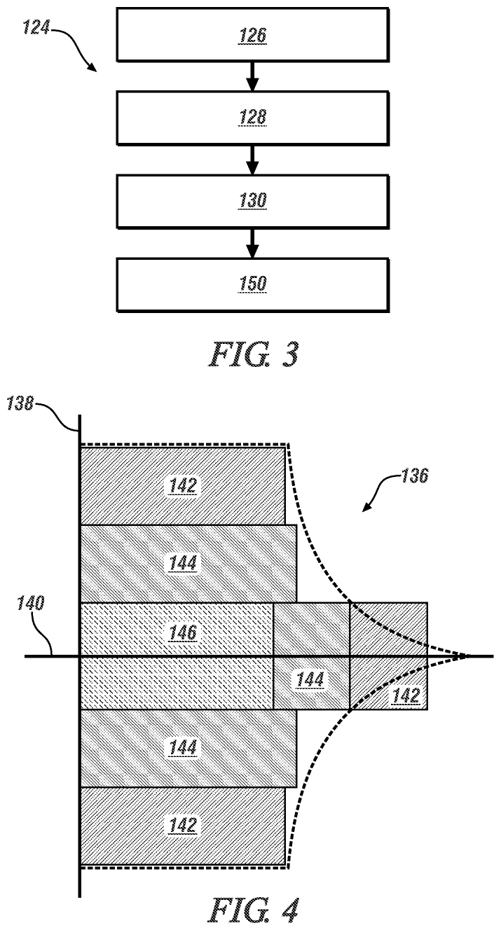

FIG. 3 illustrates a flowchart 124 of a method for variable slew rate powering of an electric machine in accordance with one aspect of the present disclosure. The flowchart 124 may be reduced to practice as one or more algorithms and calibrations. The method is predominantly described with respect to powering an embodiment of the electric machine 14 that is configured for converting an AC input to a mechanical output suitable for propelling a vehicle. However, the present disclosure fully contemplates the method being useful for powering other types of electric machines. Block 126 relates to a performance characteristics process whereby the gate controller 38 or other functioning element determines performance characteristics for a plurality of semiconductor switches 56, 54 included within each of a plurality of hybrid switch power modules 75 configured for converting a DC output 30 to an AC input 32 suitable for powering the electric machine 14. The performance characteristics may relate to a wide variety of parameters, constraints, abilities, and other aspects of the semiconductor switches 56, 54, including those that may differentiate capabilities of the semiconductors switches 56, 54 relative to each other. Depending on the technology of the semiconductor switches 56, 54, one of the semiconductor switches 56, 54 included onboard one of the hybrid switch power modules 75 may be more efficient, less expensive, more reliable, have higher operating boundaries than another one of the semiconductor switches 56, 54 included onboard the same hybrid switch power modules 75. These performance characteristics may be analyzed to determine situations when one of semiconductor switches 56, 54 may be more favored than other semiconductor switches 56, 54 and/or when conditions may warrant use of both semiconductor switches 56, 54 simultaneously.

Block 128 relates to an operating conditions process whereby the gate controller 38 or other functioning element may determine operating conditions of the electric machine 14. The operating conditions may relate to a wide variety of parameters, constraints, abilities, values, and other aspects of the electric machine 14, including those associated with present or ongoing operating conditions and/or those expected to occur in the near future. The operating conditions, for example, may relate to bearing current, motor peak voltage, motor torque, motor speed, temperature, etc. Block 130 relates to a slew rate preference process whereby the gate controller 38 or other functioning element may determine preferences for varying the ON/OFF slew rate of the semiconductor switches 56, 54, and thereby transitioning of the hybrid switch power modules 75 between opened and closed states. The slew rate preference process may include analysis of the performance characteristics associated with the semiconductor switches 56, 54 and the operating conditions of the electric machine 14 to determine whether it is desirable or optimal to prefer a faster slew rate, a slower slew rate, or a custom slew rate. A faster slew rate may result in less losses but at the consequence of less electromagnetic compatibility (EMC), i.e., more electromagnetic interference (EMI), while a slower slew rate may have the opposite result, i.e., more losses but at greater or improved EMC.

FIG. 4 illustrates a slew rate graph 136 in accordance with one aspect of the present disclosure. The graph includes a vertical axis 138 and a horizontal axis 140 to represent values useful in selecting or differentiating between desired slew rates at certain times.

The values included in the axes 138, 140 may be delineated according to the various performance characteristics of the semiconductor switches 56, 54 and/or the operating conditions of the electric machine 14.

For non-limiting purposes, the vertical axis 138 is described as corresponding with motor torque and the horizontal axis 140 is described as corresponding with motor speed. The graph 136 indicates a plurality of slew rate regions 142, 144, 146 defined relative to boundaries set according to motor torque and speed, however, similar demarcations may be defined and/or the motor torque and speed may be related or extrapolated, according to voltage, current, temperature, etc.

The slew rate regions 142, 144, 146 may correspond with slew rates desired for differing combinations of motor torque and speed, which in the illustrated configuration includes a first region 142, a second region 144, and a third region 146.

The first region 142 may be associated with a slew rate slower than the second region 144 and the second region 144 may be associated with a slew rate slower than the third region 146. The use of three slew rates is presented for non-limiting purposes based on the above-described variable resistance circuits 82, 84 including three different combinations of resistors, i.e., each combination of resistors being associated with a difference in rate.

As one skilled in the art may appreciate, additional granularity in the slew rates may be achieved by including additional resistor combinations in the variable resistance circuits 82, 84 or other capabilities for adjusting biasing of the semiconductor switches 56, 54.

Returning to FIG. 3, Block 150 relates to generating control and slew rate signals for respectively turning ON/OFF the semiconductor switches 56, 54 and the slew rate associated therewith. Depending on the slew rate region 142, 144, 146, the corresponding signals may result in one or both semiconductor switches 56, 54 being controlled between ON and OFF states. Returning to FIG. 4, the first region 142 may include both semiconductor switches 56, 54 being in the ON state, which may be referred to as a dual mode, with the resistors set to provide the first slew rate, the second region 144 may include both semiconductor switches 56, 54 being in the ON state with the resistors set to provide the second slew rate, and the third region 146 may include the first semiconductor switch being in the ON state while the second semiconductor switch 54 is in the OFF state with the resistors set to provide the third slew rate. The first, second, and third regions 142, 144, 146 are shown to repeat or be used at multiple locations as the use thereof may be desirable for more than one range of operating conditions. Additional slew rate graphs, charts, lookup tables, algorithms, formulas, and the like may be used to similarly define differing slew rate regions, particularly depending on desired preference. This, for example, may include defining differing slew rate regions as a function of efficiency, optimal loss, non-optimal loss, high loss, EMC, EMI, etc.

As supported above, the variable slew rate gate drive system may be beneficial in mitigating impacts of different turn-on/turn-off characteristics of two device types of semiconductor switches to ensure synchronized switching, controlling two or more different device types for use independently or in parallel, keeping those semiconductor switches within rated operation while achieving higher efficiency by having discrete slew rates for corner case operation of each of the devices individually and/or optimized slew rates for operating regions important for minimal losses, providing gate driver flexibility and configurability that avoids limiting the semiconductors types that can be used in a hybrid switch power module, and/or decreased switching losses. The variable slew rates may be created by having at least two sets of gate resistors per transistor technology for both turn-on and turn-off (4 or more sets per technology), such as four sets of selectable gate resistances (Rg) for SiC MOSFET semiconductor switches and four sets of selectable gate resistances for Si IGBT semiconductor switches. The two sets of gate resistors, for turn-on and turn-off, can be used individually or in parallel, creating at least three sets of slew rates per transistor technology for turn-on and three sets for turn-off per transistor technology. The variable slew rates may be used to keep the semiconductor switches with the rated operational boundaries at maximum output current and maximum input voltage, while being able to decrease losses in the regions where the semiconductor switch is used the most. In addition to ensuring the semiconductor switches operate within rated voltage and can be as efficient as possible, the multiple slew rate design may be beneficial with current sharing and balancing between the transistor technologies through controlling turn-on and turn-off delays between the technologies independently to accommodate potential intrinsic or necessary delays for operation. Additionally, gate drive specifics may be used in selecting gate voltages needed for the semiconductor switches, ensuring the semiconductor switches may be held off, overcurrent protected, and overvoltage protected, optionally with simplification of PWM control.

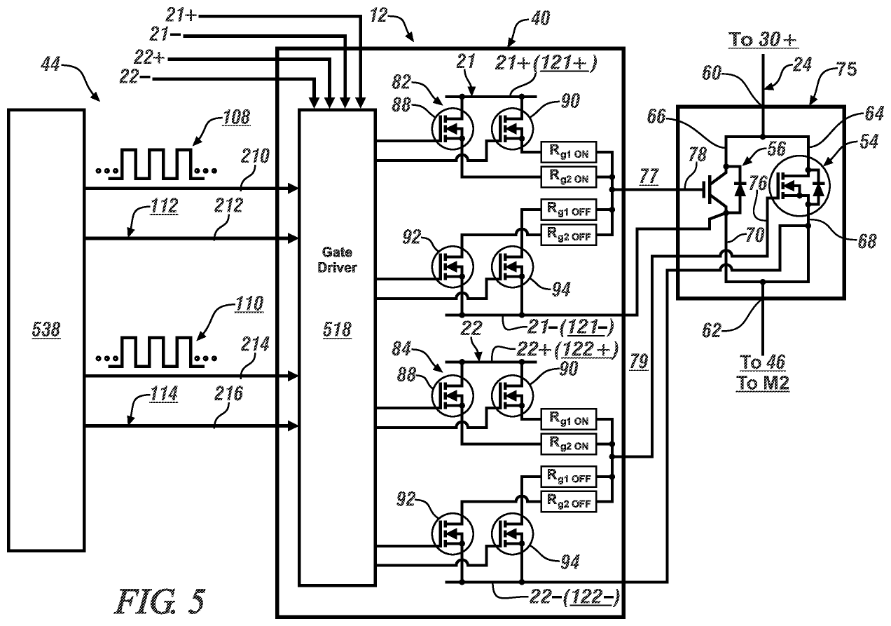

FIG. 5 illustrates a partial schematic view of another embodiment of the gate drive system 12 and PIM 16 of the EPS 10, including one of the gate drive circuits 40 and a first of the first hybrid switch power modules M1 75. The circuit topology and configuration are representative of how each of the plurality of gate drive circuits 40 may be arranged and controlled to interact with each of the other hybrid switch power modules 75, i.e., hybrid switch power modules M2, . . . . M6. The gate drive system 12 includes gate controller 538, gate drive circuit 40, and hybrid switch power module 75, which connects between one of the positive power rail (as illustrated) or the negative power rail 22, and to one of the AC power links 46, 48, 50 of the electric machine 14, as shown with reference to FIG. 1.

FIG. 5 further schematically illustrates one embodiment of a circuit topology for generating and transferring the plurality of control signals 44 between embodiments of the gate controller 538 and the gate driver 518 to implement control of the corresponding hybrid switch power module 75 via the variable resistance circuits 82, 84 of the gate drive circuit 40 of the gate drive system 12 for PIM 16.

The gate controller 538 generates the plurality of control signals 44 in response to a request for output torque from the electric machine 14. In this embodiment, the plurality of control signals 44 includes the first and second PWM control signals 108,110 and the first and second slew rate signals 112, 114. In this embodiment, the circuit topology includes a first direct wired point-to-point link 210, a first SPI link 212, a second direct wired point-to-point link 214, and a second SPI link 216. The first PWM control signal 108 is communicated via the first direct wired point-to-point link 210, the first slew rate signal 112 is communicated via the first SPI link 212, the second PWM control signal 110 is communicate via the second direct wired point-to-point link 214, and the second slew rate signal 114 is communicated via the second SPI link 216. The gate driver 518 generates a plurality of discrete control signals for controlling the respective buffer switches 88, 90, 92, 94 of the variable resistance circuits 82, 84 to control the first and second semiconductor switches 54, 56, respectively. As such, the current load being carried by the first semiconductor switch 54 is controlled to be equal to the current load being carried by the second semiconductor switch 56 during ON/OFF transients and during ON/OFF transients. Other illustrated elements are described with reference to the description associated with FIGS. 1 and 2.

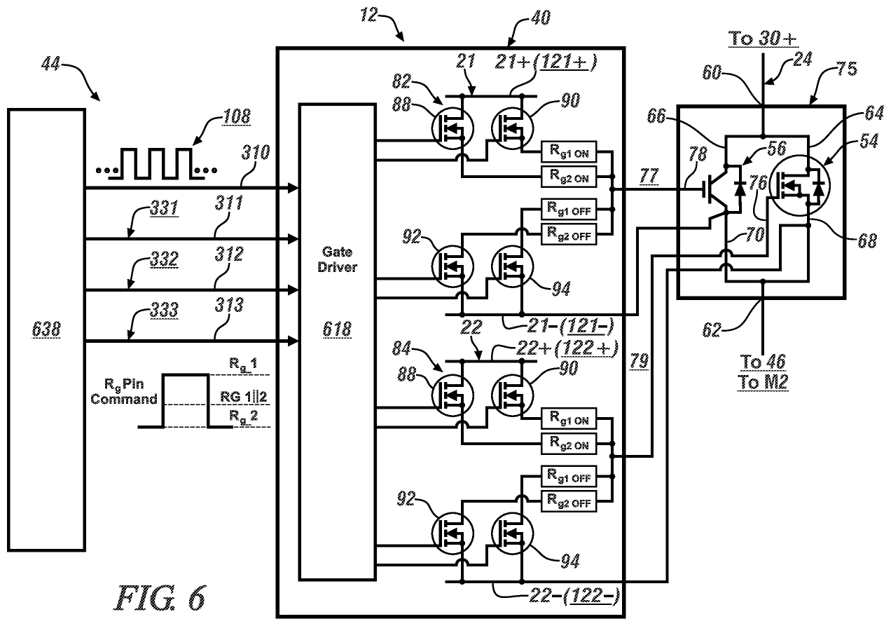

FIG. 6 illustrates a partial schematic view of another embodiment of the gate drive system 12 and PIM 16 of the EPS 10, including one of the gate drive circuits 40 and a first of the first hybrid switch power modules M1 75. The circuit topology and configuration are representative of how each of the plurality of gate drive circuits 40 may be arranged and controlled to interact with each of the other hybrid switch power modules 75, i.e., hybrid switch power modules M2, . . . . M6. The gate drive system 12 includes gate controller 638, gate drive circuit 40, and hybrid switch power module 75, which connects between one of the positive power rail (as illustrated) or the negative power rail 22, and to one of the AC power links 46, 48, 50 of the electric machine 14, as shown with reference to FIG. 1. For a system having multilevel pins, there needs to be one set of pins per buffer stage with three separate levels. In the case where the slew rate setting can be changed between switching edges. A single pin may be used where turn-on slew rate is set for the on-edge of the PWM signal, and the turn off slew rate is set after the PWM on edge, but before the off-edge of the PWM signal. Both of these solutions can have applications that balance controller throughout and processing speed, with the number of pins on the gate controller 638.

FIG. 6 further schematically illustrates another embodiment of a circuit topology for transferring the plurality of control signals 44 between gate controller 638 and gate driver 618 to implement control of the corresponding hybrid switch power module 75 via the variable resistance circuits 82, 84 of the gate drive circuit 40 of the gate drive system 12 for PIM 16. Other illustrated elements are described with reference to the description associated with FIGS. 1 and 2.

In this embodiment, the plurality of control signals 44 includes the first and second PWM control signals 108,110 and the first and second slew rate signals 112, 114. In this embodiment, the circuit topology includes a first direct wired point-to-point link 310, a first direct wired point-to-point discrete link 311, a second direct wired point-to-point discrete link 312, and direct wired point-to-point digital link 313. The first PWM control signal 108 is communicated via the first direct wired point-to-point link 210, the first transistor 1 Rg Pin signal 331 for controlling the variable resistance circuit 82 is communicated via the first direct wired point-to-point discrete link 311, the second transistor 2 Rg Pin signal 332 for controlling the variable resistance circuit 82 is communicated via the second direct wired point-to-point discrete link 312, and first and second slew rate signals 333 are translated to multilevel digital signals that are communicated via the direct wired point-to-point digital link 313. The gate driver 618 generates a plurality of discrete control signals for controlling the respective buffer switches 88, 90, 92, 94 of the variable resistance circuits 82, 84 to control the first and second semiconductor switches 54, 56, respectively. As such, the current load being carried by the first semiconductor switch 54 is controlled to be equal to the current load being carried by the second semiconductor switch 56 during ON/OFF transients and during ON/OFF transients. Other illustrated elements are described with reference to the description associated with FIGS. 1 and 2.

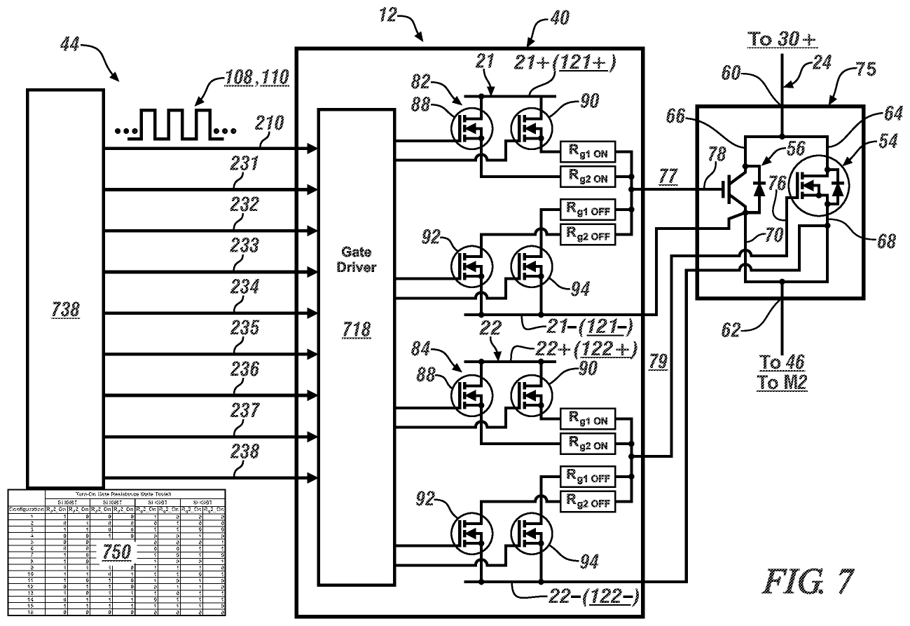

FIG. 7 illustrates a partial schematic view of another embodiment of the gate drive system 12 and PIM 16 of the EPS 10, including one of the gate drive circuits 40 and a first of the first hybrid switch power modules M1 75. The circuit topology and configuration are representative of how each of the plurality of gate drive circuits 40 may be arranged and controlled to interact with each of the other hybrid switch power modules 75, i.e., hybrid switch power modules M2, . . . . M6. The gate drive system 12 includes gate controller 738, gate drive circuit 40 including gate driver 718, and hybrid switch power module 75, which connects between one of the positive power rail (as illustrated) or the negative power rail 22, and to one of the AC power links 46, 48, 50 of the electric machine 14, as shown with reference to FIG. 1.

FIG. 7 further schematically illustrates a circuit topology for transferring the plurality of control signals 44 between the gate controller 738 and the gate driver 718 to implement control of the corresponding hybrid switch power module 75 via the variable resistance circuits 82, 84 of the gate drive circuit 40 of the gate drive system 12 for PIM 16.

In this embodiment, the plurality of control signals 44 includes the first and second PWM control signals 108,110 and the first and second slew rate signals 112, 114. In this embodiment, the circuit topology includes a plurality of direct wired point-to-point discrete links 210, 231-238 arranged between the gate controller 38 and the gate driver 18. Other illustrated elements are described with reference to the description associated with FIGS. 1 and 2.

The first and second PWM control signals 108, 110 are communicated via the direct wired point-to-point link 210.

The point-to-point discrete links 231-238 communicate discrete signals, i.e., digital “1” or digital “0”. The first and second slew rate signals 112, 114 are translated, by the gate controller 738, to multi-bit discrete signals, e.g., an 8-bit signal, which are communicated as discrete values over the point-to-point discrete links 231-238 to the gate driver 718. The gate driver 718 generates a plurality of discrete control signals for controlling the respective buffer switches 88, 90, 92, 94 of the variable resistance circuits 82, 84 to control the first and second semiconductor switches 54, 56, respectively. As such, the current load being carried by the first semiconductor switch 54 is controlled to be equal to the current load being carried by the second semiconductor switch 56 during ON/OFF transients and during ON/OFF transients. The 8-bit signal representing the first and second slew rate signals 112, 114, is captured in a logic table 750.

FIGS. 8-1 and 8-2 schematically illustrate, with continued reference to the elements described with reference to FIGS. 1 and 2, partial cutaway plan views of an integrated circuit 800, 810 that houses elements of a pair of the hybrid switch power modules 75, such as may be employed for one of the legs 24, 26, or 28 of the PIM 16, including an upper first semiconductor switch 54U, an upper second semiconductor switch 56U, a lower first semiconductor switch 54L, and a lower second semiconductor switch 56L. In one embodiment, the upper first semiconductor switch 54U and the lower first semiconductor switch 54L are WBG devices, and the upper second semiconductor switch 56U and the lower second semiconductor switch 56L are IGBT devices. Pins for the upper first semiconductor switch 54U and the lower first semiconductor switch 54L include gate 76, drain 64, and source 68. Pins for the upper second semiconductor switch 56U and the lower second semiconductor switch 56L include source or emitter 70, drain or collector 66, and gate 78.

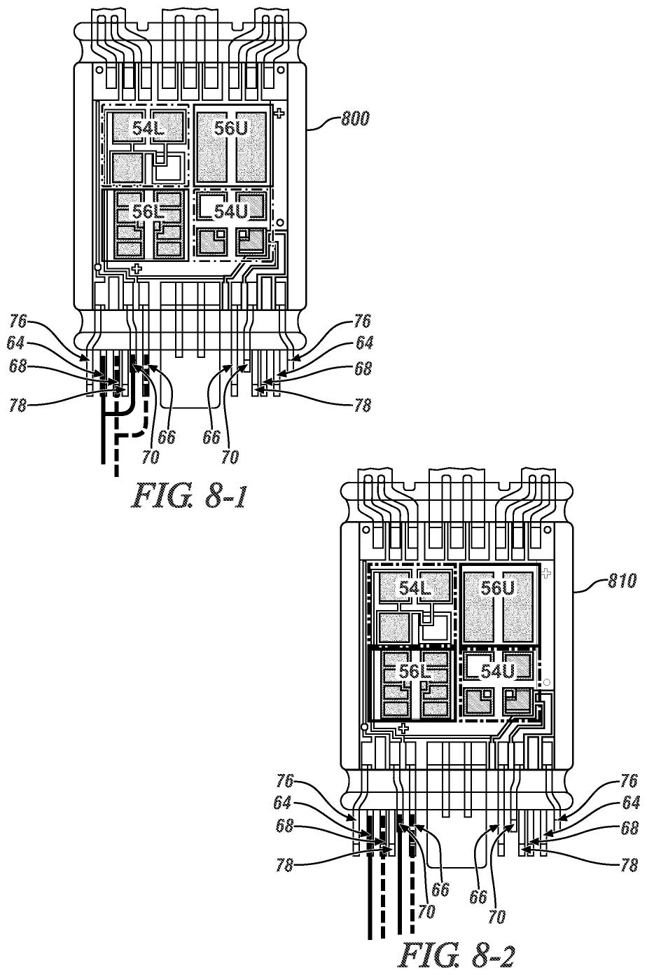

FIG. 8-1 schematically depicts an arrangement of the integrated circuit 800 wherein the gate driver 18 is configured to execute a single desaturation (or DESAT) event by tying drain 64 and emitter 70 together, and tying source 68 and collector 66 together to effect overcurrent protection.

FIG. 8-2 schematically depicts an arrangement of the integrated circuit 810 wherein the gate driver 18 is configured to execute multiple desaturation (or DESAT) events by individually accessing the drain 64 and emitter 70, and individually accessing the source 68 and collector 66 to effect overcurrent protection.

Overcurrent protection may be accomplished employing configurable DESAT control. The configurability settings are used for operation of each of the upper and lower first and second semiconductor switches individually, and another setting for combined operation of two of the semiconductor switches. The overcurrent protection can be realized through a single configurable pin, or through multiple DESAT pins where the input/output of the transistors have their own kelvin pins. The configuration of the DESAT can be based on the on-off state table with specific configurations assigned to the different states. Overcurrent protection is achieved based on power module design. The gate driver has at least one pin for overcurrent protection. This overcurrent protection is configurable and has specific configurable settings for each of the Gate Command States in a state table. If two separate pins exist for controlling or monitoring the transistor drain/collector and source/emitter, the gate driver can have more than one pin for current monitoring. The single pin and dual pin overcurrent protection can be used for modules with on-die current sensing also, utilizing configurable thresholds based on gate state selection. The configurability can include, e.g., current thresholds, voltage thresholds, blanking time, etc.

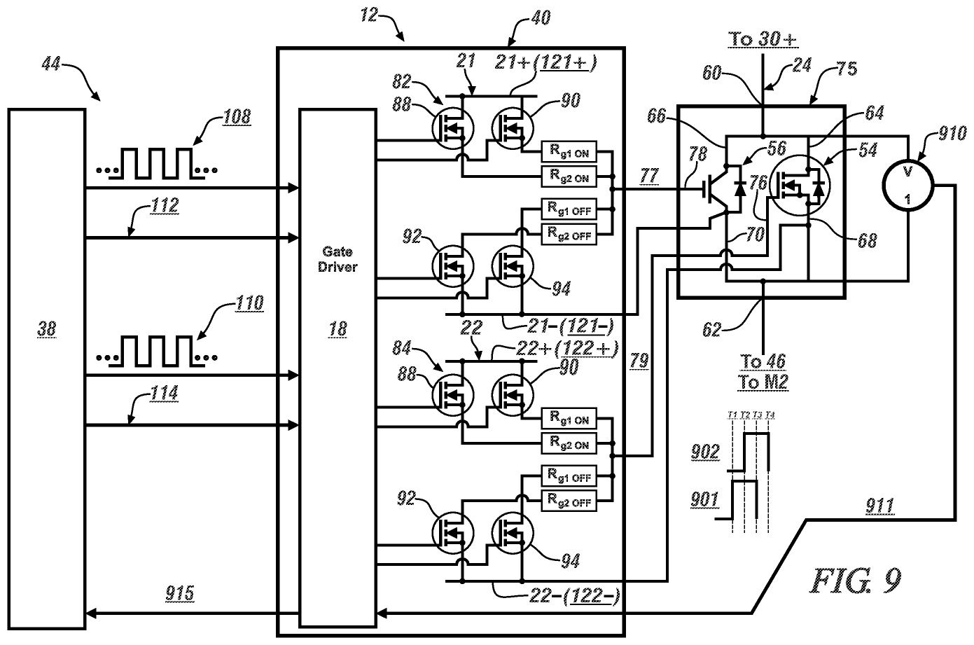

FIG. 9 schematically illustrates elements of an embodiment of a fault monitoring and detection arrangement that may be employed on an embodiment of the gate drive system 12 for the PIM 16 that includes gate controller 38, gate driver 18, and hybrid switch power module 75 that are described herein. The circuit topology is arranged to include monitoring electrical parameters across the hybrid switch power module 75, wherein the electrical parameters may be related to one or more of overcurrent detection, overvoltage, blanking time, etc. In this embodiment, a desaturation protection circuit including desaturation sensor 910 is arranged to monitor electrical potential 911 or another electrical parameter across both the first and second semiconductor switches 54, 56 of the hybrid switch power module 75, with a feedback link coupled to the gate driver 18. The gate driver 18 communicates the electrical potential 911 from the desaturation sensor 910 to the gate controller 38 via link 915, which is a SPI link in one embodiment.

In operation, the gate controller 38 commands the gate driver 18 to generate first and second control signals 901, 902, which are transferred to the respective gates 76, 78 of the first and second semiconductor switches 54, 56, while monitoring voltage across the hybrid switch power module 75. In one embodiment, and as shown, the first and second control signals 901, 902 are pulsed on and pulse off signals, which are offset in time. In one embodiment, the first and second control signals 901, 902 are arranged as respective first and second square wave signals, wherein the second square wave signal lags the first square wave signal. The electrical potential 911 is communicated to the gate controller 38. The gate controller 38 parses and analyzes the electrical potential 911, comparing it with overcurrent and desaturation thresholds to identify which of the first and second semiconductor switches 54, 56 is functional, or has a potential fault such as a short circuit or an open circuit. The information may then be used to isolate the faulty switch, if present, and operate the functional semiconductor switch when the identified fault indicates an open circuit. This can be done through pulsing each semiconductor type independently during a vehicle idle or start up check while the vehicle is not in motion. If the switch has a failed-short fault, the voltage sensed across the switch will be near 0 volts whether being switched ON or OFF. If the switch has a failed-open fault, it will read a high voltage, i.e., near half of the current battery pack voltage whether being switched ON or OFF. If the switch is functional, it will read a voltage near zero when commanded to the ON state, and greater than or near half of the system voltage when commanded to the OFF state.

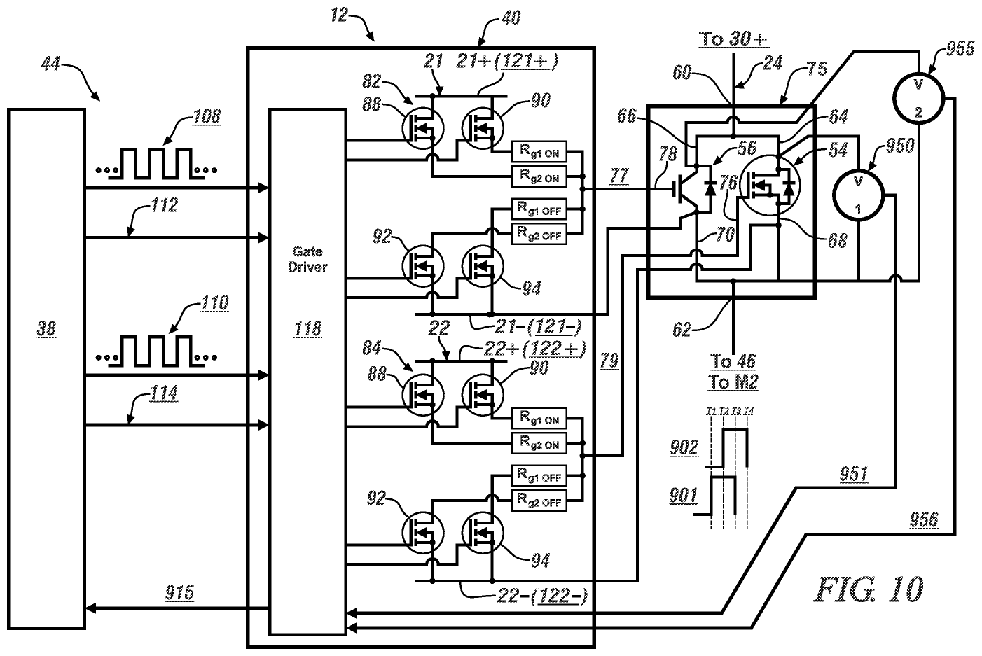

FIG. 10 schematically illustrates elements of another embodiment of a fault monitoring and detection arrangement that may be employed on an embodiment of the gate drive system 12 for PIM 16 that includes gate controller 38, gate driver 18, and hybrid switch power module 75 that are described herein. The circuit topology is arranged to include monitoring electrical potential across each of the first and second semiconductor switches 54, 56 of the hybrid switch power module 75. In this embodiment, the desaturation protection circuit includes a first desaturation sensor 950 that is internal to the gate driver 40 is arranged to monitor first electrical potential 951 or another electrical parameter across the first semiconductor switch 54 of the hybrid switch power module 75, with a feedback link coupled to the gate driver 18. In like manner, the desaturation protection circuit includes a second desaturation sensor 955 that is internal to the gate driver 40 and is arranged to monitor second electrical potential 956 or another electrical parameter across the second semiconductor switch 56 of the hybrid switch power module 75, with a feedback link coupled to the gate driver 18. The gate driver 18 communicates the first and second electrical potentials 951, 956 to the gate controller 38 via link 915, which is a SPI link in one embodiment.

In operation, the gate controller 38 commands the gate driver 18 to generate first and second control signals 901, 902, which are transferred to the respective gates of the first and second semiconductor switches 54, 56, while monitoring voltage across the hybrid switch power module 75. In one embodiment, and as shown, the first and second control signals 901, 902 are pulsed on and pulse off signals, which are offset in time. The desaturation sensors 950, 955 generate first and second electrical potentials 951, 956 that are communicated to the gate controller 38. The gate controller 38 parses and analyzes the first and second electrical potential inputs 951, 956, comparing them with overcurrent and desaturation thresholds to identify which of the first and second semiconductor switches 54, 56 is functional, or has a potential fault such as a short circuit or an open circuit. The information may then be used to isolate the faulty switch, if present, and operate the functional semiconductor switch if the identified fault indicates an open circuit. This can be done through pulsing each semiconductor type independently during a vehicle idle or start up check while the vehicle is not in motion. If the switch has a failed-short fault, the voltage sensed across the switch will be near 0, if the switch has a failed-open fault, it will read a high voltage near half of the current battery pack voltage. If the switch is functional, it will read a voltage near zero when commanded to the ON state, and near half of the system voltage when commanded to the OFF state.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

1. A gate drive system for a multi-phase power inverter, comprising:
a gate controller, a gate drive circuit, and a hybrid switch power module;
wherein the hybrid switch power module is integrated into a phase leg of the multi-phase power inverter;
wherein the hybrid switch power module includes a first semiconductor switch connected in parallel with a second semiconductor switch between one of a positive power rail or a negative power rail and an AC power link of the phase leg of the multi-phase power inverter, the first semiconductor switch having a first set of performance characteristics and the second semiconductor switch having a second set of performance characteristics differing at least partially from the first set of performance characteristics;
wherein the gate drive circuit includes a gate driver, a first variable resistance circuit that connects to the first semiconductor switch, and a second variable resistance circuit that connects to the second semiconductor switch;
wherein the gate controller generates a plurality of control signals that are communicated to the gate drive circuit to control the hybrid switch power module;
wherein the gate controller is connected to the gate drive circuit via a plurality of links; and
wherein the gate controller communicates the plurality of control signals to the gate drive circuit via the plurality of links.

2. The gate drive system of claim 1,
wherein the plurality of control signals includes a first PWM control signal and a first slew rate signal;
wherein the plurality of links includes a direct wired point-to-point link between the gate controller and the gate driver;
and wherein the gate controller communicates the first PWM control signal to the gate driver via the direct wired point-to-point link to control the first semiconductor switch.

3. The gate drive system of claim 2,
wherein the plurality of links further includes a serial peripheral interface (SPI) link; and
wherein the gate controller communicates the first slew rate signal to the gate driver via the SPI link to control the first semiconductor switch.

4. The gate drive system of claim 2,
wherein the plurality of links further includes a plurality of point-to-point discrete links;
wherein the first slew rate signal is arranged as a multi-bit discrete signal; and
wherein the gate controller communicates the multi-bit discrete signal to the gate driver via the plurality of point-to-point discrete links.

5. The gate drive system of claim 2,
wherein the plurality of links further includes a point-to-point digital link;
wherein the first slew rate signal is arranged as a multilevel digital signal; and
wherein the gate controller communicates the multilevel digital signal to the gate driver via the point-to-point digital link.

6. The gate drive system of claim 1, further comprising a desaturation protection circuit being connected to the hybrid switch power module.

7. The gate drive system of claim 1, further comprising a desaturation sensor arranged to monitor an electrical potential across the hybrid switch power module; wherein the gate controller is arranged to:
generate first and second control signals, the first and second control signals being transferred to respective gates of the first and second semiconductor switches; and
determine, via the desaturation sensor, the electrical potential across the hybrid switch power module in response to the first and second control signals.

8. The gate drive system of claim 7, further comprising the gate controller being arranged to detect a fault in one of the first and second semiconductor switches based upon the electrical potential across the hybrid switch power module that was determined in response to the first and second control signals.

9. The gate drive system of claim 1, further comprising a desaturation sensor arranged to monitor an electrical potential across one of the first and second semiconductor switches of the hybrid switch power module;
wherein the gate controller is arranged to:
generate first and second control signals, the first and second control signals being transferred to a gate of the one of the first and second semiconductor switches;
determine, via the desaturation sensor, the electrical potential across the one of the first and second semiconductor switches in response to the first and second control signals; and
detect a fault in the one of the first and second semiconductor switches based upon the electrical potential.

10. A multi-phase power inverter coupled to an electric machine, comprising:
a gate drive system including a gate controller operatively connected to a plurality of gate drive circuits and a plurality of hybrid switch power modules;
wherein the plurality of hybrid switch power modules are integrated into a plurality of phase legs of the multi-phase power inverter;
wherein the plurality of phase legs are arranged between a positive DC power rail and a negative DC power rail;
wherein the plurality of phase legs are coupled to the electric machine via a plurality of AC power links;
wherein each hybrid switch power module includes a first semiconductor switch connected in parallel with a second semiconductor switch between one of the positive DC power rail or the negative DC power rail and one of the plurality of AC power links of the respective phase leg of the multi-phase power inverter, the first semiconductor switch having a first set of performance characteristics and the second semiconductor switch having a second set of performance characteristics differing at least partially from the first set of performance characteristics;
wherein the gate drive circuit includes a gate driver, a first variable resistance circuit that connects to the first semiconductor switch, and a second variable resistance circuit that is connects the second semiconductor switch;
wherein the gate controller generates a plurality of control signals that are communicated to the gate drive circuit to control the plurality of hybrid switch power modules;
wherein the gate controller is connected to the gate drive circuit via a plurality of links; and
wherein the gate controller communicates the plurality of control signals to the gate drive circuit via the plurality of links.

11. The multi-phase power inverter of claim 10,
wherein the plurality of control signals includes a first PWM control signal and a first slew rate signal;
wherein the plurality of links includes a direct wired point-to-point link between the gate controller and the gate driver;
and wherein the gate controller communicates the first PWM control signal to the gate driver via the direct wired point-to-point link to control the first semiconductor switch.

12. The multi-phase power inverter of claim 11,
wherein the plurality of links further includes a serial peripheral interface (SPI) link; and
wherein the gate controller communicates the first slew rate signal to the gate driver via the SPI link to control the first semiconductor switch.

13. The multi-phase power inverter of claim 11,
wherein the plurality of links further includes a plurality of point-to-point discrete links;
wherein the first slew rate signal is arranged as a multi-bit discrete signal; and
wherein the gate controller communicates the multi-bit discrete signal to the gate driver via the plurality of point-to-point discrete links.

14. The multi-phase power inverter of claim 11,
wherein the plurality of links further includes a point-to-point digital link;
wherein the first slew rate signal is arranged as a multilevel digital signal; and
wherein the gate controller communicates the multilevel digital signal to the gate driver via the point-to-point digital link.

15. The multi-phase power inverter of claim 10, further comprising a desaturation protection circuit being connected to one of the plurality of hybrid switch power modules.

16. The multi-phase power inverter of claim 10, further comprising a desaturation sensor arranged to monitor an electrical potential across the one of the plurality of hybrid switch power modules; wherein the gate controller is arranged to:
generate first and second control signals, the first and second control signals being transferred to respective gates of the first and second semiconductor switches; and
determine, via the desaturation sensor, the electrical potential across the one of the plurality of hybrid switch power modules in response to the first and second control signals.

17. The multi-phase power inverter of claim 16, further comprising the gate controller being arranged to detect a fault in one of the first and second semiconductor switches based upon the electrical potential across the one of the plurality of hybrid switch power modules that was determined in response to the first and second control signals.

18. The multi-phase power inverter of claim 10, further comprising a desaturation sensor arranged to monitor an electrical potential across one of the first and second semiconductor switches of the one of the plurality of hybrid switch power modules;
wherein the gate controller is arranged to:
generate first and second control signals, the first and second control signals being transferred to a gate of the one of the first and second semiconductor switches;
determine, via the desaturation sensor, the electrical potential across the one of the first and second semiconductor switches in response to the first and second control signals; and
detect a fault in the one of the first and second semiconductor switches based upon the electrical potential.

19. The multi-phase power inverter of claim 18, wherein the gate controller is arranged to generate the first and second control signals, wherein the first and second control signals comprise first and second square wave signals, and wherein the second square wave signal lags the first square wave signal.

20. An electrified vehicle system, comprising:
a gate drive system, a multi-phase power inverter, and an electric machine;
the multi-phase power inverter being operatively connected to the electric machine via a plurality of phase legs;
the gate drive system including a gate controller, a gate drive circuit, and a plurality of hybrid switch power modules;
wherein the plurality of hybrid switch power modules are electrically coupled to the plurality of phase legs of the multi-phase power inverter;
wherein each of the plurality of hybrid switch power modules includes a first semiconductor switch connected in parallel with a second semiconductor switch between one of a positive high-voltage (HV) DC power rail or a negative HV DC power rail and one of the plurality of phase legs of the multi-phase power inverter, the first semiconductor switch having a first set of performance characteristics and the second semiconductor switch having a second set of performance characteristics differing at least partially from the first set of performance characteristics;
wherein the gate drive circuit includes a gate driver, a first variable resistance circuit that connects to the first semiconductor switch, and a second variable resistance circuit that connects to the second semiconductor switch;
wherein the gate controller generates a plurality of control signals that are communicated to the gate drive circuit to control the hybrid switch power module;
wherein the gate controller is connected to the gate drive circuit via a plurality of links; and
wherein the gate controller communicates the plurality of control signals to the gate drive circuit via the plurality of links.
